(19) United States
(12) Patent Application Publication
(10) Pub. No.: US 2010/0259568 A1
(43) Pub. Date: Oct. 14, 2010

(54) ELECTRO-OPTIC DEVICE, DRIVING METHOD THEREOF AND ELECTRONIC DEVICE

(75) Inventor: Toshiyuki KASAI, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/753,363

(22) Filed: Apr. 2, 2010

(30) Foreign Application Priority Data
Apr. 13, 2009 (JP) 2009-096895

(51) Int. Cl. G09G 5/10

(52) U.S. Cl. 345/690

(57) ABSTRACT

An electro-optic device is provides, which includes: a plurality of unit circuits disposed corresponding to intersection of a plurality of scan lines and a plurality of data lines; control lines extended corresponding to the plurality of each of the scan lines; a scan line driving circuit that sequentially selects one of the scan lines for each drive period within each unit period, and selects all or a portion of the plurality of control lines; and a data line driving circuit that outputs a data potential, in response to grayscale data of the unit circuit corresponding to the scan line selected in the drive period within the unit period, to each of the data lines, for each period within the unit period which is a writing period before the drive period is started.

### BACKGROUND

1. Technical Field

The present invention relates to an electro-optic device including an organic EL (electroluminescent) element, a liquid crystal and the like, a driving method thereof and an electronic device.

2. Related Art

Hitherto, the electro-optic devices including an organic EL element and the like have been provided as electro-optic elements. In this electro-optic device, various driver circuits are included in order to supply predetermined current or voltage for the organic EL element and the like. Such driver circuit may include, for example, a capacitor element that is connected in parallel in addition to the organic EL element. In such a case, the data potential is supplied to the positive electrode of the organic EL element and one electrode of the capacitor element, and the reference potential is supplied to the negative electrode of the organic EL element and the other electrode of the capacitor element. By this, it is possible to perform current supply, which arises from the charges accumulated in the capacitor element in response to the data potential, to the organic EL element, whereby to perform stable drive and the like of the organic EL element.

As electro-optic devices like this, there has been known an electro-optic device disclosed in, for example, JP-A-2000-122608.

However, the electro-optic device described above has the problems as follows. That is, in order to make the amount of emission (time integration value of emission brightness) of the organic EL element be a sufficient value, there is a need to make the amount of charges to be accumulated in the capacitor element, so that there is a need to make the capacitance of the capacitor element be a significantly large value. However, due to the relationship in which a physical space to be allowed for each driving circuit, the large capacitance value is difficult to be implemented.

Therefore, in order to solve the above problem, the applicant of the invention proposes a technique disclosed in US Patent Application Publication No. 2009/0195534. In the disclosure, there is disclosed a technique in which a capacitor element included in each of the plurality of driver circuits (unit circuit) is used for driving each organic EL element. As a simple example, in which the driving circuits are simply arranged only in one row and the number of the driving circuits is N (therefore, the numbers of the capacitor elements and the organic EL elements are also N), when any one of the organic EL elements is driven, firstly, N capacitor elements included in all the driving circuits are simultaneously charged according to a data potential corresponding to the organic EL element, and secondly, the discharge (that is, current supply) of the N capacitor elements is performed toward the organic EL element.

According to this configuration, the defect described above disappears almost.

Nonetheless, there is a room for improvement in the technique. That is, in general, in the electro-optic device as described above, a function of adjusting brightness of the entire image which is displayed by the organic EL elements is required. In order to implement the function, in the related art, emission control transistors are provided between the organic EL elements and the driving transistors which is a current supply source, and a driving circuit for vertically connecting these is employed. According to this configuration, by controlling a period of time in which the emission control transistors is in a conduction state, the emission time of the organic EL elements can be adjusted, and the brightness of the entire image can be adjusted.

However, in the technique according to US Patent Application Publication No. 2009/0195534, since there is no emission control transistor as described above, the configuration and the method described above cannot be employed.

### SUMMARY

An advantage of some aspects of the invention is that it provides an electro-optic device, a driving method thereof and an electronic device capable of addressing at least a portion of the above-mentioned problems.

Further, another advantage of some aspects of the invention is that it provides an electro-optic device, a driving method thereof and an electronic device capable of addressing the problem associated with the electro-optic device, the driving method thereof and the electronic device of such an aspect.

According to a first aspect of the invention, An electro-optic device is provides, which includes: a plurality of unit circuits disposed corresponding to intersection of a plurality of scan lines and a plurality of data lines; control lines extended corresponding to the plurality of each of the scan lines; a scan line driving circuit that sequentially selects one of the scan lines for each drive period within each unit period, and selects all or a portion of the plurality of control lines; and a data line driving circuit that outputs a data potential, in response to grayscale data of the unit circuit corresponding to the scan line selected in the drive period within the unit period, to each of the data lines, for each period within the unit period which is a writing period before the drive period is started. In the electro-optic device, the plurality of each of the unit circuits includes: an electro-optic element having a grayscale in response to the data potential; a capacitor element which has a first and second electrodes and of which the first electrode is connected to a capacitor line; a first switching element, disposed between the second electrode of the capacitor element and the data line, that causes the second electrode and the data line to be in a state of conduction by conducting at the time of selection of the control line in the writing period; and a second switching element, disposed between the data line and the electro-optic element, that causes the data line and the electro-optic element to be in a state of conduction by conducting at time of selection of the scan line in the drive period.

According to the electro-optic device of the invention, for example, the following operation can be realized.

That is, at the first operation, the capacitor element within the unit circuit connected to the data line is charged in the writing period. Here, the capacitor element to be charged is limited to a capacitor element included in the unit circuit of which the first switching element is in a conduction state, that is, a capacitor element having the second electrode which is in a conduction state with the data line by selecting the control line corresponding to the first switching element. At the second operation, in a drive period after this writing period, discharging of the capacitor element to be charged in the first operation is performed on the electro-optic element included in the unit circuit corresponding to one scan line selected. In this case, the charges relating to the discharging are supplied from the second electrode via the data line to the electro-optic element.

In such operations, depending on how many control lines are selected among a plurality of control lines, in other words, depending on the number of the capacitor elements involved in charging and discharging mentioned above, the amount of current supplied to which electro-optic element finally altered. According to the configuration, it is possible to adjust brightness of the electro-optic element, and to perform the adjustment of brightness of the whole image.

In the electro-optic device of the invention, it is preferable that all of the plurality of control lines is not selected all at once in one of the writing periods.

According to this aspect, all of a plurality of control lines does not have the same chance to be selected all at once. In other words, the selected ones among the plurality of control lines should be necessarily a portion of the plurality of control lines. According to the configuration, as is obvious from the above, the purport of the invention is more obvious.

However, in the aspect according to the invention, there is, of course, not excluded the case where all of a plurality of control lines is selected all at once in one writing period. When the electro-optic element is caused to emit light in the highest brightness, this is because such an aspect is naturally assumed. On the occasion of general analysis of the invention, care should be taken of this point.

Further, in the electro-optic device of the invention, it is preferable that one end of the first switching element is connected to the data line, and that the other end thereof is connected to the second electrode and is connected to one end of the second switching element.

According to this aspect, one of the more particular and appropriate configurations according to the electro-optic device of the invention is provided. From the above-mentioned description, such a configuration includes an aspect where the first and second switching elements and the electro-optic element are serially connected in this order when viewed from the data line.

Meanwhile, an aspect which is further embodied according to this aspect will be described as a first embodiment among embodiments stated later.

Alternatively, in the electro-optic device of the invention, it is preferable that one end of the first switching element is connected to a first node on the data line, one end of the second switching element is connected to the first node, and the second switching element is disposed between the second electrode and the electro-optic element via the first node and the first switching element.

According to this aspect, one of the more particular and appropriate configurations according to the electro-optic device of the invention is provided. From the above-mentioned description, such a configuration includes an aspect where the first switching element and the capacitor element exist in one side thereof, and the second switching element and the electro-optic element exist in the other side, when viewed on the basis of the data line (in other words, an aspect where both of these are connected to each other so as to be in a parallel relationship when viewed on the basis of the data line).

Compared to the last aspect, this aspect is characterized particularly in that selection of the control line and selection of the scan line can be performed mutually independently.

Meanwhile, an aspect which is further embodied according to this aspect, including mutually independent selection described presently, will be described as a second embodiment among embodiments stated later.

Further, in the electro-optic device of the invention, it is preferable that a control line which is not selected, among the plurality of control lines, within one of the writing periods is defined by a predetermined positional relationship between the control line and one of the scan lines selected in the drive period corresponding to the writing period, and that the predetermined positional relationship is constantly the same, regardless of which is one of the scan lines to be selected among the plurality of scan lines.

According to the embodiment, the relationship between the position of the electro-optic element to be driven and the position of the capacitor element involved in discharging at the time of driving can be always set in a state of being balanced. For example, simply, when the case where four unit circuits are arranged in one row is assumed, the “predetermined positional relationship” can be expressed as “◯◯◯” when the electro-optic element in a first unit circuit is driven (that is, when a scanning line corresponding to the electro-optic element is selected), “◯◯◯.” when a second unit circuit is driven, “◯◯◯” when a third unit circuit is driven, and “◯◯◯” when a fourth unit circuit is driven. In this case, here, “◯” means the capacitor element which is involved in discharging, and “” means the capacitor element which is not involved in discharging. The arrangement of “◯” or “” represents the arrangement of the unit circuits (meanwhile, the control lines corresponding to the capacitor elements involved in discharging are selected, and the control lines corresponding to the capacitor elements not involved in discharging is not selected). When the “predetermined positional relationship” is defined in language in advance, “the relationship in which the capacitor element in the unit circuit which is separated backward by two from the unit circuit including the electro-optic element to be driven” can be defined.

As described above, according to this embodiment, the arrangement balance of the capacitor elements involved in discharging (and charging) is good with respect to the electro-optic elements to be driven, and even when any one of the plural electro-optic elements is emitted, occurrence of brightness unevenness and the like can be suppressed since the current supply condition is equal.

In the meantime, the specified example according to this embodiment will be described in the embodiment to be described later.

In this aspect, it is preferable that a relationship, where one of the control lines corresponding to one of scan lines which is adjacent to one of the scan line selected in the drive period is not selected constantly, is included in the predetermined positional relationship.

According to the aspect, when “◯” and “” described above are used as a marking example, for example, the mark will be expressed as “◯◯◯” when the electro-optic element in the first unit circuit is driven, “◯◯◯” when the electro-optic element in the second unit circuit is driven, “◯◯◯” when the electro-optic element in the third unit circuit is driven, and “◯◯◯” when the electro-optic element in the fourth unit circuit is driven (in addition, this aspect includes various cases of, “◯◯”, “◯◯”, “◯◯.” and “◯◯”).

In the aspect, one of the best suitable examples is proposed on the basis of that the electro-optic element and the capacitor element involved in discharging are assumed to be arranged in balance therebetween.

Meanwhile, a specified aspect according to this aspect will be further explained in embodiments to be described later in addition to the last aspect described above.

Further, in the aspect where the first and second switching elements are connected to the first node, it is preferable that a control line selected among the plurality of control lines is constantly fixed in a predetermined period.

According this aspect, for example, since an operation of changing the control line to be selected for each one horizontal period is not required to be performed, in order to be capable of being realized in the last and the previous two aspects, reduction in power consumption and the like is possible.

Meanwhile, the “predetermined period” termed in this aspect may be, for example, one vertical period as described a bit later. Alternatively, it may be freely determined to the “P horizontal period” (P is an integer corresponding to the upper limit of the number of the scan lines) or, the “extremely long time” and the like. Although the latter expression is somewhat ambiguous, it is meant by the expression that a case is included where there is practically no change in the control line to be selected during the time of using the electro-optic device.

Further, in the electro-optic device of the invention, it is preferable that the predetermined period is one frame.

According to the aspect, since the predetermined period is one vertical period, firstly, as described in the example, the number of times of the change operations is reduced compared with that the control lines to be selected is changed in every one horizontal period, so that the consumption power reduce effect is obtained. In addition, secondly, in this aspect, since the control line to be selected is changed in every one vertical period without performing the change operation at all, brightness unevenness reduce effect as described above, that is, brightness unevenness reduce effect such that the current supply condition can be equal with respect to the electro-optic elements is obtained also in this aspect.

As described above, according to this aspect, two effects conflicting with each other can be obtained at the same time.

According to a second aspect of the invention, an electronic device including various types of electro-optic devices described above is provided.

Since the electronic device according to the invention includes various types of electro-optic devices described above, it is possible to easily adjust brightness of the whole image.

According to a third aspect of the invention, provided is a method of driving an electro-optic device that includes a plurality of control lines extended corresponding to a plurality of each of scan lines, and a plurality of unit circuits corresponding to each of the control lines, and includes an electro-optic element having a predetermined grayscale by charge discharging of a capacitor element within the corresponding unit circuit. The method includes: causing a first switching element between the capacitor element within the unit circuit corresponding to the control line and a data line to be in a conduction state by selecting all or a portion of the plurality of control lines, and accumulating charges, in response to a data potential output to the data line, in the capacitor element, and causing a second switching element between the electro-optic element within the unit circuit corresponding to the scan line and the data line to be in a conduction state by selecting one of the scan lines.

According to the embodiment of the invention, it is possible to appropriately drive the electro-optic device of the invention described above.

### BRIEF DESCRIPTION OF THE DRAWINGS

The invention will be described with reference to the accompanying drawings, wherein like numbers reference like elements.

FIG. 1 is a block diagram illustrating an electro-optic device according to a first embodiment of the invention.

FIG. 2 is a circuit diagram illustrating the details of a unit circuit and peripheries of a data potential generating section constituting the electro-optic device of FIG. 1.

FIG. 3 is a timing diagram for describing an operation of the electro-optic device of FIG. 1 and FIG. 2.

FIG. 4 is a first explanatory diagram visually representing charge and discharge of a capacitor element (C1) in the electro-optic device operating in accordance with FIG. 3.

FIG. 5 is a second explanatory diagram visually representing charge and discharge of the capacitor element (C1) in the electro-optic device operating in accordance with FIG. 3.

FIG. 6 is an explanatory diagram for describing a time-dependent change of a positional relationship between a position of the capacitor element to be charged and discharged and an electro-optic element to be emitted, in the electro-optic device according to the first embodiment.

FIG. 7 is a diagram having the same meaning as in FIG. 6, and an explanatory diagram for describing a mode different from that of FIG. 6.

FIG. 8 is a diagram illustrating the configuration of a comparative example for the configuration of the electro-optic device according the first embodiment.

FIG. 9 is a timing diagram for describing an operation of the configuration of the comparative example of FIG. 8.

FIG. 10 is a circuit diagram illustrating the details of a unit circuit and peripheries of a data potential generating section constituting an electro-optic device according to a second embodiment of the invention.

FIG. 11 is a timing diagram for describing an operation of the electro-optic device of FIG. 10.

FIG. 12 is a first explanatory diagram visually representing charge and discharge of the capacitor element (C1) in the electro-optic device operating in accordance with FIG. 11.

FIG. 13 is a second explanatory diagram visually representing charge and discharge of the capacitor element (C1) in the electro-optic device operating in accordance with FIG. 11.

FIG. 14 is an explanatory diagram for describing a time-dependent change of a positional relationship between a position of the capacitor element to be charged and discharged and an electro-optic element to be emitted, in the electro-optic device according to the second embodiment.

FIG. 15 is a circuit diagram illustrating the details of the unit circuit and peripheries of the data potential generating section constituting a modified example (addition of an auxiliary capacitor element) of the electro-optic device according to the first and second embodiments of the invention.

FIG. 16 is a diagram having the same meaning as in FIG. 6, FIG. 7 and FIG. 14, and an explanatory diagram for describing a mode different from those of these drawings.

FIG. 17 is a perspective view illustrating an electronic device to which the electro-optic device according to the invention is applied.

FIG. 18 is a perspective view illustrating another electronic device to which the electro-optic device according to the invention is applied.

FIG. 19 is a perspective view illustrating still another electronic device to which the electro-optic device according to the invention is applied.

### DESCRIPTION OF EXEMPLARY EMBODIMENTS

### First Embodiment

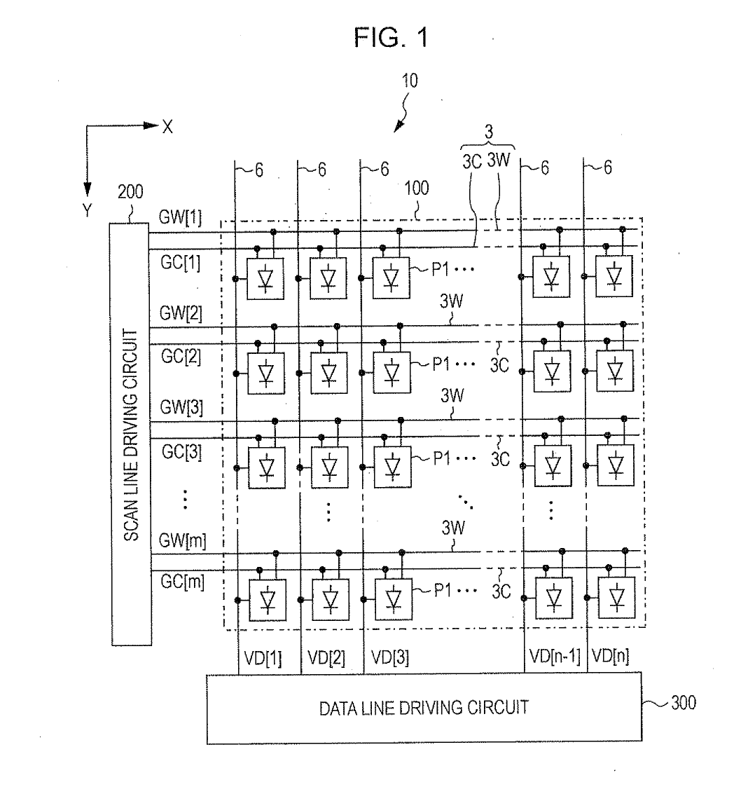

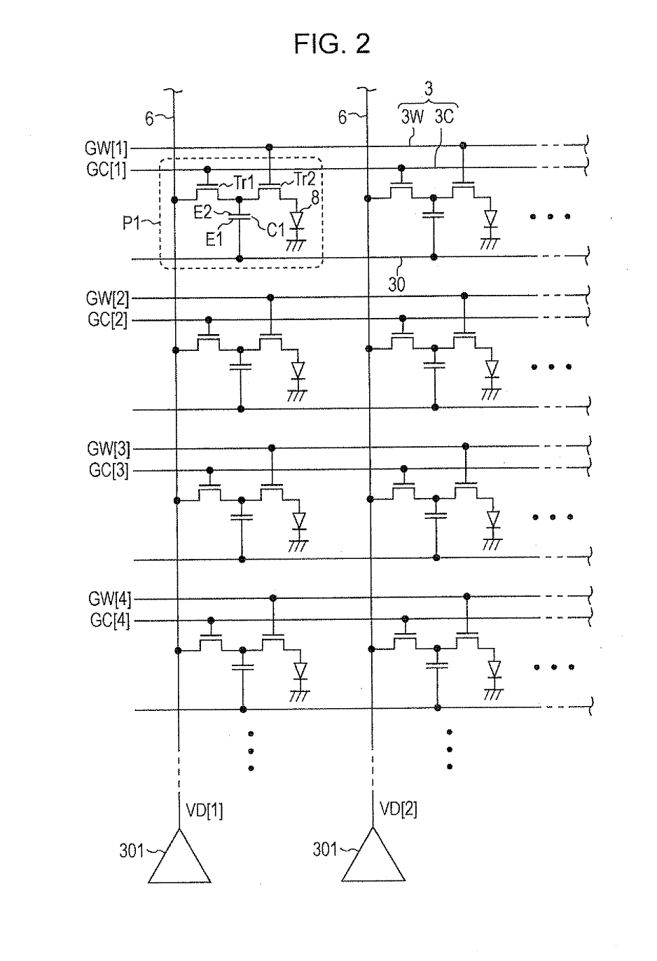

Hereinafter, the first embodiment according to the invention will be described with reference to FIG. 1 and FIG. 2. In addition to FIG. 1 and FIG. 2 mentioned herein, in each of the drawings referred to below, the ratios of dimensions of each part may be properly different from the actual condition.

In FIG. 1, an electro-optic device 10 is a device which is adopted in various types of electronic devices as a device for displaying an image, and includes a pixel array section 100 in which a plurality of unit circuits P1 is arranged in a planar shape; a scan line driving circuit 200 and a data line driving circuit 300. In the meantime, although the scan line driving circuit 200 and the data line driving circuit 300 are shown as a separate circuit in FIG. 1, the configuration where all or a portion of these circuits are composed of a single circuit may be also adopted.

As shown in FIG. 1, the pixel array section 100 is provided with m scan lines 3 extending in an X direction, and n data lines 6 extending in a Y direction perpendicular to the X direction (m and n are natural numbers). Each of the unit circuits P1 is disposed at a position corresponding to the intersection of the scan line 3 and the data line 6. Therefore, these unit circuits P1 are arranged in a matrix form of m rows×n columns.

Among the above-mentioned configurations, the m scan lines 3 include a set of two of an emission control line 3W and a charging control line 3C, respectively, as shown in FIG. 1. In other words, if the number of the scan line 3 is m, the total number of the emission control line 3W and the charging control line 3C is 2m. Each of these control lines (3W, 3C) is connected to each of the unit circuits P1 located at each row (the more specific connection state will be described later with reference to FIG. 2).

Meanwhile, with respect to the “scan line”, used in the scope of the claims, that defines the invention, the above-mentioned “emission control line 3W” corresponds to it in the first embodiment.

The scan line driving circuit 200 shown in FIG. 1 is a circuit for selecting a plurality of unit circuits P1. The scan line driving circuit 200 generates emission control signals GW[1] to GW[m] which become sequentially active, and outputs them to each of the above-mentioned emission control lines 3W. Among the emission control signals GW[i] to be supplied to the emission control line 3W included in the scan line 3 of the i-th row (i is an integer satisfying the transition of the emission control signal GW[i] to an active state means selection of the n unit circuits P1 belonging to the i-th row.

In addition, the scan line driving circuit 200 generates charging control signals GC[1] to GC[m] which become properly active, and outputs them to each of the above-mentioned charging control line 3C. Among the charging control signals GC[i] to be supplied to the charging control line 3C included in the scan line 3 of the i-th row, the transition of the charging control signal GC[i] to an active state means permission of charging to a capacitor element C1 described later which is included in the n unit circuits P1 belonging to the i-th row.

The data line driving circuit 300 shown in FIG. 1 generates data potentials VD[1] to VD[n] in response to each grayscale data of the n unit circuits P1 corresponding to the emission control line 3W to be selected by the scan line driving circuit 200 and outputs them to the data line 6. In what follows, the data potential VD to be output to the data line 6 of the j-th column (j is an integer satisfying 1≦j≦n) may be transcribed in VD[j].

FIG. 2 is a circuit diagram illustrating the detailed electrical configuration relating to each of the unit circuits P1.

Each of the unit circuits P1 includes an electro-optic element 8, a capacitor element C1, a first transistor Tr1, and a second transistor Tr2, as shown in FIG. 2.

The electro-optic element 8 is an OLED (Organic Light Emitting Diode) element in which an emission layer made of organic EL materials is interposed between a positive electrode and a negative electrode, and is disposed between the second transistor Tr2 and a constant potential line (ground line) to which a constant potential is supplied, as shown in FIG. 2. Here, the positive electrode is provided for each unit circuit P1, and is a separate electrode controlled for each unit circuit P1. The negative electrode is a common electrode which is commonly provided to the unit circuit P1. The negative electrode is connected to the constant potential line to which a constant potential is supplied. Meanwhile, the positive electrode may be a common electrode, and the negative electrode may be a separate electrode.

The capacitor element C1 is an element that maintains a data potential VD[j] to be supplied from the data line 6. As shown in FIG. 2, the capacitor element C1 includes a first electrode E1 connected to a capacitor line 30, and a second electrode E2 connected to each of the first transistor Tr1 and the second transistor Tr2.

Meanwhile, the capacitor line 30 to which a fixed potential is supplied is commonly connected to each of the unit circuits P1. In addition, although the ground potential is supplied to the constant potential line, for example, a negative potential is supplied to the constant potential line, the data potential VD[n] exhibiting the highest brightness among the data potentials VD[j] may be a positive potential, and the data potential VD[1] exhibiting the lowest brightness among the data potentials VD[j] may be a negative potential. That is, the ground potential may exist between the data potential VD[n] and the data potential VD[1]. In this way, it is possible to reduce the amplitude of the data potential VD[j] for the ground potential, and to achieve low power consumption.

In addition, a data potential generating section 301 included in the data line driving circuit 300 shown in FIG. 1 is shown in FIG. 2. The data potential generating section 301 is provided so as to correspond to each of the data line 6 as shown in FIG. 2, and generates and supplies the data potentials VD[j] for each of them individually.

The first transistor Tr1 is an N-channel type, and is a switching element that causes the second electrode E2 of the capacitor element C1 and the data line 6 to be in a conduction state by conducting at the time of selection of the charging control line 3C. As shown in FIG. 2, a source of the first transistor Tr1 is connected to the second electrode E2 of the capacitor element C1, and a drain thereof is connected to the data line 6.

A gate of the first transistor Tr1 is connected to the charging control line 3C. Herewith, when the charging control signal GC[i] transits to an active state, the first transistor Tr1 belonging to the i-th row is in an on state, to thereby cause the second electrode E2 and the data line 6 to be in a conduction state. On the other hand, when the charging control signal GC[i] transits to an inactive state, the first transistor Tr1 belonging to the i-th row is in an off state, to thereby cause the second electrode E2 and the data line 6 to be in a non-conduction state.

The second transistor Tr2 is an N-channel type, and is a switching element that causes the second electrode E2 of the capacitor element C1 and the electro-optic element 8 to be in a conduction state by conducting at time of selection of the emission control line 3W. As shown in FIG. 2, the source of the second transistor Tr2 is connected to the positive electrode of the electro-optic element 8, and the drain thereof is connected to the second electrode E2 of the capacitor element C1.

The gate of the second transistor Tr2 is connected to the emission control line 3W. Herewith, when the emission control signal GW[i] transits to an active state, the second transistor Tr2 belonging to the i-th row is in an on state, to thereby cause the second electrode E2 and the electro-optic element 8 to be in a conduction state. On the other hand, when the emission control signal GW[i] transits to an inactive state, the second transistor Tr2 is in an off state, to thereby cause the second electrode E2 and the electro-optic element 8 to be in a non-conduction state.

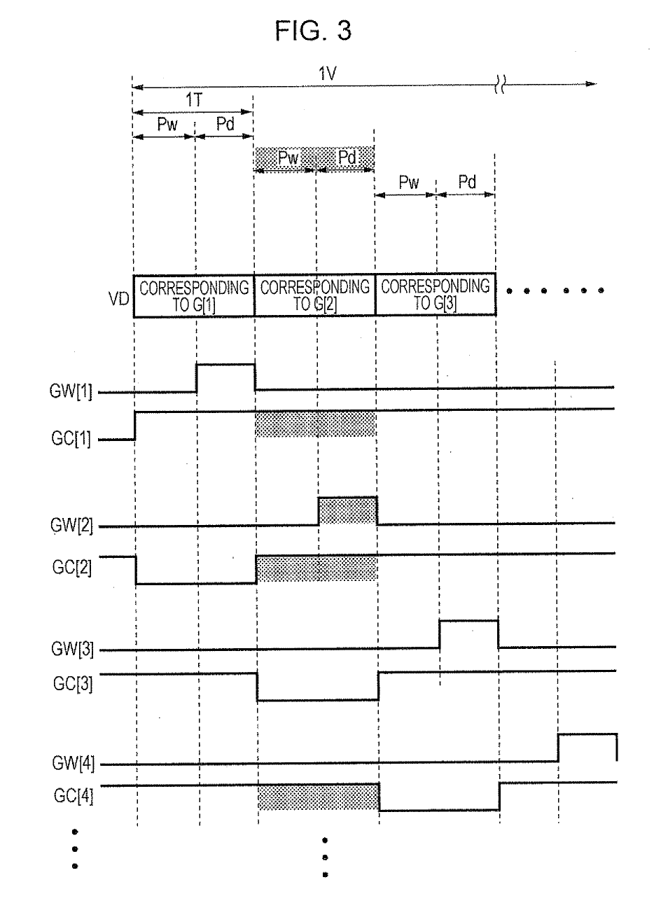

Next, in addition to FIG. 1 and FIG. 2 which are previously referred to, reference is made to FIG. 3 to FIG. 6 to describe an example of an operation and an action of the electro-optic device 10 according to the first embodiment.

The electro-optic device 10 is based on the operations of the following “i” and “ii”.

i. Writing Operation

The writing operation is an operation of maintaining the data potential VD[j] corresponding to an emission grayscale of the electro-optic element 8 included in each of the unit circuits P1 corresponding to a certain scan line 3, in the capacitor element C1 within the unit circuit P1 belonging to the row which includes the corresponding electro-optic element 8. For example, the data potential VD[3] (see FIG. 1) as to the electro-optic element 8 corresponding to the scan line 3 of the second row and located at the third row is maintained by a plurality of capacitor elements C1 within each of the unit circuits P1 located at the third row (however, it is not always true that all of the plurality of capacitor elements C1 are used. This point will be immediately described later).

ii. Emission Operation (Operation of Electro-Optic Element)

The emission operation is an operation of light emitting the corresponding electro-optic element 8 on the basis of the data potential VD[j] maintained in the capacitor element C1 in the “i” operation. This operation includes supplying the emission control signal GW[i] which is active to the emission control line 3W of which the unit circuit P1 including the electro-optic element 8 is included in the corresponding scan line 3, and thereby causing the second transistor Tr2 within the unit circuit P1 to be in a conduction state. Hereby, the electro-optic element 8 has a supply of a current in response to charges accumulated in the capacitor element C1, to thereby cause it to emit light.

The electro-optic device 10 according to the first embodiment, basically, operates on the basis of appropriate combination of the above-mentioned “i” and “ii” operations. However, as to this point, the details thereof, for example, are as follows.

First, in a writing period Pw shown in the leftmost side of FIG. 3, the scan line driving circuit 200 supplies the charging control signals GC[1], GC[3], GC[4], . . . , GC[m] which are active states to the remaining charging control lines 3C except the charging control line 3C included in the scan line 3 of the second row. Hereby, the first transistors Tr1 located at each of the remaining rows except the second row are on states, therefore, the capacitor elements C1 belonging to each of the corresponding rows are in a state of conduction with the data line 6.

Under such a circumstance, the data potential generating section 301 generate the data potential VD[j], and supplies it to each of the corresponding data lines 6. The data potential VD[j] corresponds to the electro-optic element 8 within each of the unit circuits P1 located at the first row (see a phrase “corresponding to G[1]” in FIG. 3).

As described above, completed is the above-mentioned “i. writing operation” as to the electro-optic element 8 within each of the unit circuit P1 located at the first row. As seen from the above, in the writing period Pw, among all of the capacitor elements C1 within the pixel array section 100, only the remaining capacitor elements C1 except the capacitor elements C1 belonging to the second row are involved in charging, and a plurality of capacitor elements C1 belonging to the respective of the first column, the second column, . . . , and the n-th column accumulates charges in response to the data potentials VD[1], VD[2], and VD[n], respectively.

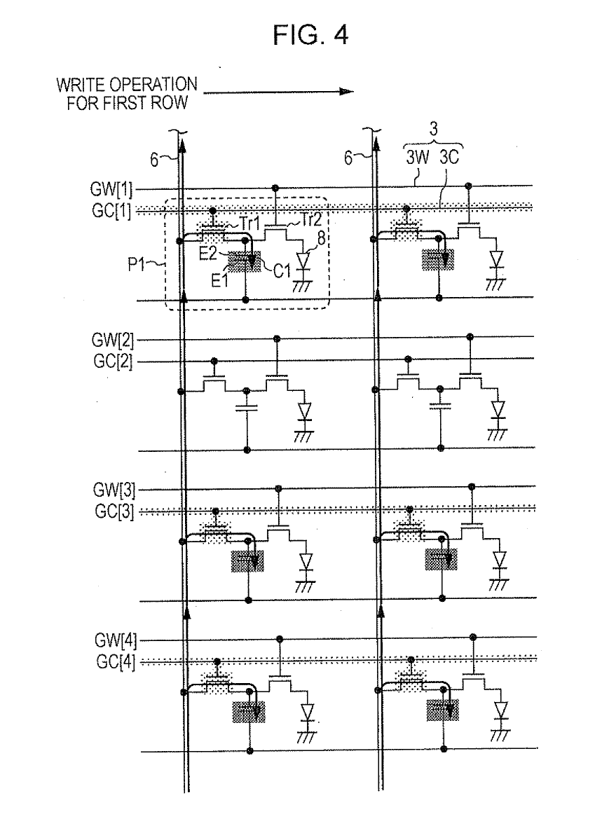

FIG. 4 visually represents the above-mentioned operations. That is, in FIG. 4, a case is shown where a plurality of capacitor elements C1 belonging to each of the data lines 6 accumulates charges in response to VD[1], VD[2], . . . , and VD[n] for each row (see, in FIG. 4, the heavy and solid line arrows, and the hatching portions associated with them). In this case, the capacitor element C1 located at the second row is not involved in the charging like this.

As described above, completed is the above-mentioned “i. writing operation” as to the electro-optic element 8 within each of the unit circuits P1 located at the first row.

Subsequently, in a drive period Pd adjacent to the writing period Pw, the scan line driving circuit 200 supplies the emission control signal GW[1] in an active state to the emission control line 3W included in the scan line 3 of the first row. Hereby, the electro-optic elements 8 corresponding to the emission control line 3W emit light all at once (the above-mentioned [ii] emission operation). At this time, the current flowing into the corresponding electro-optic element 8 is based on the amount of charge accumulated in a plurality of capacitor elements C1 described above. Particularly in this case, the number of the capacitor elements C1 involved in discharging like this is in accord with the number of the capacitor elements C1 involved in charging in the foregoing. That is, in the present case, the number of the capacitor elements C1 involved in discharging is (m−1).

As described above, one unit period 1T is terminated (see the upside in FIG. 3).

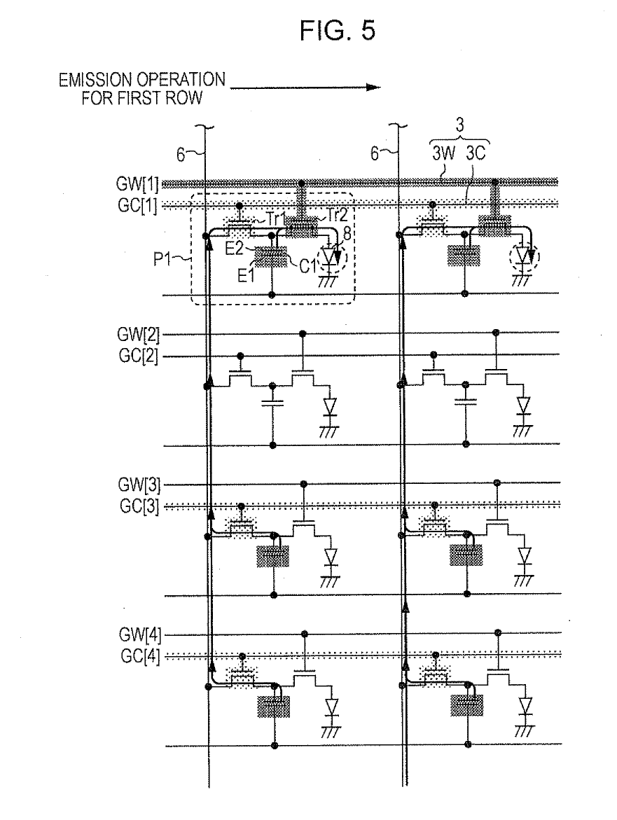

FIG. 5 visually represents the above-mentioned operation. That is, in FIG. 5, a case is shown where the emission control signal GW[1] in an active state is supplied to the emission control line 3W of the first row, so that the second transistor Tr2 belonging to this emission control line 3W becomes an on state, and then each electro-optic element 8 corresponding to it emits light. Further, at this time, a case is also shown where the supply of the current to the electro-optic element 8 is performed in response to charges of each capacitor element C1 except the second row described above (see, in FIG. 5, the heavy and solid line arrows, and the hatching portions associated with them).

From this time on, the above-mentioned operation is repeatedly performed while sequentially moving the electro-optic element 8 to be emitted to the downside of FIG. 4 and FIG. 5 (or FIG. 1 and FIG. 2), in other words, line-sequentially selecting the emission control line 3W. In the meantime, a period 1V shown in FIG. 3 means one vertical scanning period which is a period until the selection of all the emission control lines 3W takes a round.

However, in the midst of this repetition, care should be taken of the movement of the charging control signal GC[1]. That is, generally speaking, in the unit period 1T relating to the unit circuit P1 located at the i-th row, the charging control signals GC[1], GC[2], . . . , GC[i], GC[i+2], . . . , GC[m] which are in an active state are supplied to each of the remaining charging control lines 3C except the charging control line 3C of the (i+1)-th row. At this time, when the unit circuit P1 to be selected is located at a final row (that is, the m-th row), signals to be in an active state are the charging control signals GC[2], . . . , GC[m] except the charging control signal GC[1]. In other words, the charging control line 3C to be in a non-selected state circulates.

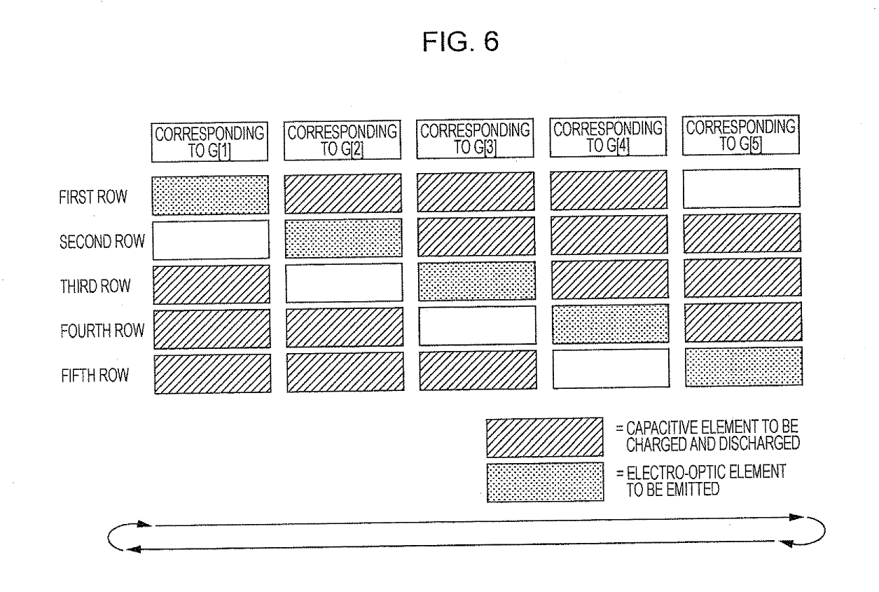

As such a result, in the first embodiment, the electro-optic element 8 to be emitted, as shown in FIG. 3 or FIG. 6, constantly undergoes discharging of the charges from each of the remaining capacitor elements C1 except the capacitor element C1 belonging to the row just behind itself, with the exception of the electro-optic element 8 belonging to the m-th row. FIG. 6, for the purpose of simplification, is an explanatory diagram for describing a time-dependent change of the positional relationship between a position of the capacitor element C1 to be charged and discharged in the case where the unit circuit P1 exists only in 5 rows×1 column, and the electro-optic element 8 to be emitted. In the drawing, a quadrangle in which hatching is not performed represents the capacitor element C1 not to be charged.

Meanwhile, it may be said that the first embodiment provides the linguistically expressed relationship as one specific example of the “predetermined positional relationship” termed in the invention, when “the charging control line 3C, which corresponds to the capacitor element C1 belonging to the row (the first row when the electro-optic element 8 to be emitted is located at the m-th row) just behind the electro-optic element 8 to be emitted, is not constantly selected”, including the case of the above-mentioned circulation.

Such a case is included in one specific example of the case where “the predetermined positional relationship is constantly the same, regardless of which is one of the scan lines to be selected among the plurality of scan lines” in the invention. Considering existence of the circulation, depending on the point of view, the “predetermined positional relationship” may be viewed not to be “constantly the same” in, for example, a case of “corresponding to G[5]” and a case of “corresponding to G[1]” of FIG. 6. However, since the unified linguistic expression as stated above is possible, such a case is also included as one specific example of “constantly the same” in the invention.

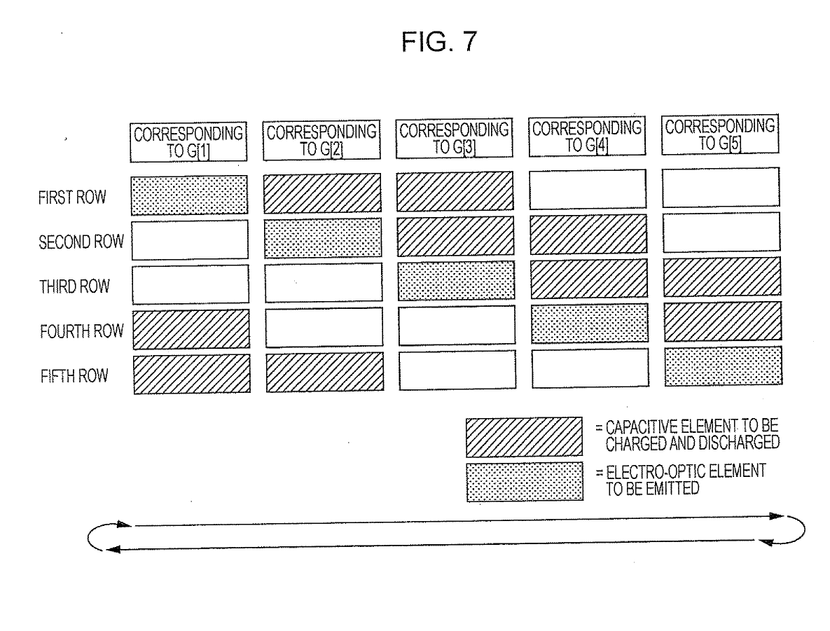

In addition, the above-mentioned operation example is nothing but presenting just an example. In the first embodiment, it is basically freely determined which mode of the charging control line 3C is selected, in response to line-sequential selection of the emission control line 3W. For example, as shown in FIG. 7 having the same meaning as in FIG. 6, in the unit period 1T for the unit circuit P1 located at the i-th row, it is also possible to adopt a mode in which the charging control signals GC[1], GC[2], . . . , GC[i], GC[i+3], . . . , GC[m] which are an active state are supplied to each of the remaining charging control lines 3C except the charging control lines 3C of the (i+1)-th row and the (i+2)-th row, and the like (the circulation of the charging control line 3C to be non-selected is similar to the case of FIG. 6. See FIG. 7).

In this case of FIG. 7, compared to FIG. 6, since the number of the capacitor elements C1 involved in charging and discharging is reduced, the brightness of the whole image is lowered.

With the electro-optic device 10 according to the first embodiment performing the above-mentioned configuration and operation, the following advantage is exhibited.

(1) First, with the electro-optic device 10 according to the first embodiment, as described above, since the number of the capacitor elements Cl supplying the charges to the electro-optic element 8 to be emitted is able to be easily increased or decreased, the brightness of the whole image is able to be adjusted.

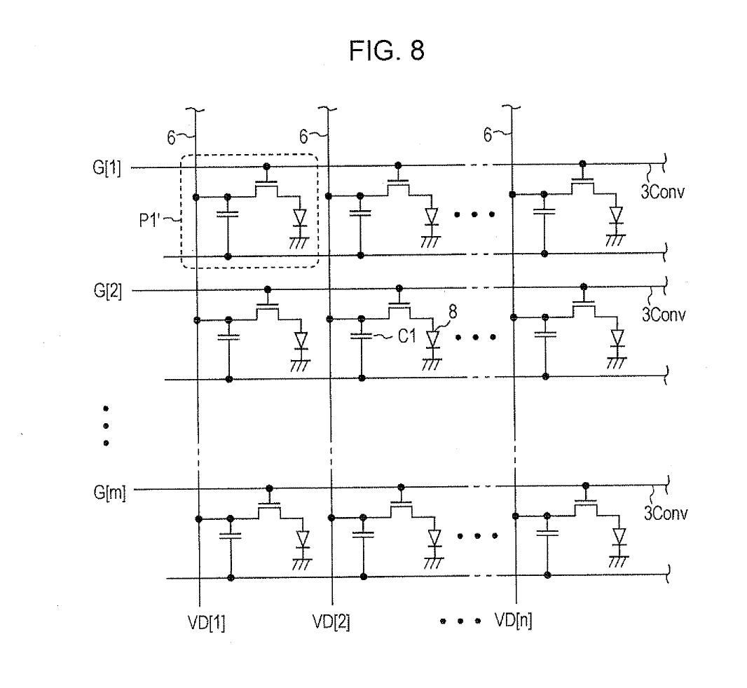

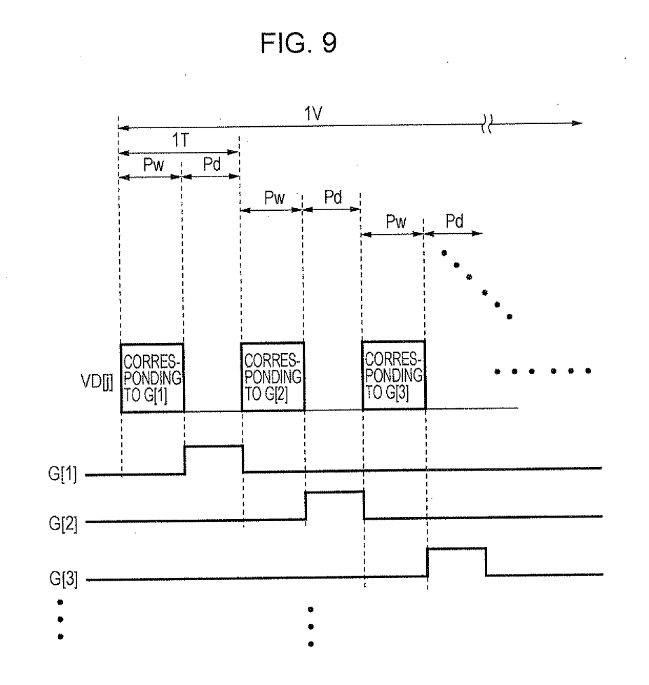

This is grasped more obviously in a comparison of the first embodiment and FIG. 8 and FIG. 9. Here, FIG. 8 is a comparative example for the configuration according to the first embodiment (see FIG. 2 for comparison), and FIG. 9 is a timing diagram relating to an operation of the configuration according to the comparative example of FIG. 8 (see FIG. 3 for comparison).

In FIG. 8, differently from FIG. 1 or FIG. 2 and the like, a scan line 3Conv is provided one by one corresponding to each row of the unit circuit P1. That is, in the first embodiment, the scan line 3 corresponding to each row includes the emission control line 3W and the charging control line 3C, whereas in the comparative example, only one interconnection exists. In addition, differently from the unit circuit P1 of the first embodiment, a unit circuit P1′ in FIG. 8 does not include a component equivalent to the first transistor Tr1, and the capacitor element C1 is directly connected to the data line 6.

In FIG. 8, an operation as shown in FIG. 9 is performed in accordance with such a configuration. In FIG. 8 and FIG. 9, when a writing operation for the electro-optic element 8 belonging to any row is performed, charging for all the capacitor elements C1 is performed all at once. In addition, when an emission operation for the electro-optic element 8 is performed, discharging for all the capacitor elements C1 is performed all at once. In other words, with such a configuration and operation, it is not possible to perform adjustment of the brightness of the whole image.

As is obvious from the above-mentioned comparison, with the first embodiment, such a drawback is not suffered.

(2) Further, with the first embodiment, in the unit period 1T relating to the unit circuit P1 located at the i-th row as described above, since the charging control line 3C of the (i+1)-th row is in a non-selected state, and the charging control line 3C to be non-selected is configured to circulate, the relationship between a position of the electro-optic element 8 to be emitted and a position of the capacitor element C1 involved in discharging is in a state where balance is constantly taken (see FIG. 6 or FIG. 7). Hereby, in the first embodiment, it is possible to have the advantage of suppressing brightness unevenness by capability to equalize current supply conditions with respect to any of the electro-optic elements 8.

### Second Embodiment

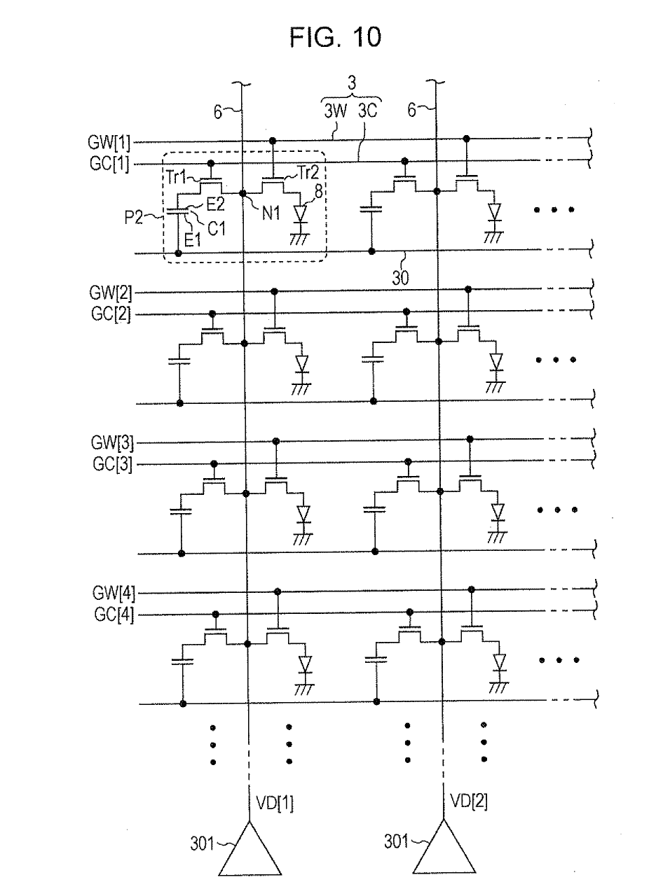

Hereinafter, a second embodiment according to the invention will be described with reference to FIG. 10 to FIG. 13. Meanwhile, the second embodiment is characterized in that a configuration of a unit circuit P2 and an operation example involved undergo a modification as viewed from the first embodiment, and is similar to the configuration and the operation or the action of the first embodiment with respect to other points. Therefore, hereinafter, the difference is mainly described, and a description of other differences is properly simplified, or is omitted.

In the second embodiment, as shown in FIG. 10, the configuration of the unit circuit P2 is different from the configuration of the unit circuit P1 according to the first embodiment. That is, in the unit circuit P2, the drain of the first transistor Tr1 is connected to a node N1 on the data line 6, and the source thereof is connected to the second electrode 52 of the capacitor element C1. On the other hand, in this unit circuit P2, the drain of the second transistor Tr2 is also connected to the node N1 on the data line 6 mentioned above, and the source thereof is connected to the positive electrode of the electro-optic element 8. Meanwhile, a mode of connection of the first electrode E1 of the capacitor element C1 and the negative electrode of the electro-optic element 8, and connection of the gates of each of the first and second transistors Tr1 and Tr2 to the charging control line 3C and the emission control line 3W are the same as those of the first embodiment.

As described above, in the second embodiment, the point that the first and second transistors Tr1 and Tr2 are commonly connected to the node N1 on the data line 6 is greatly different compared to the first embodiment.

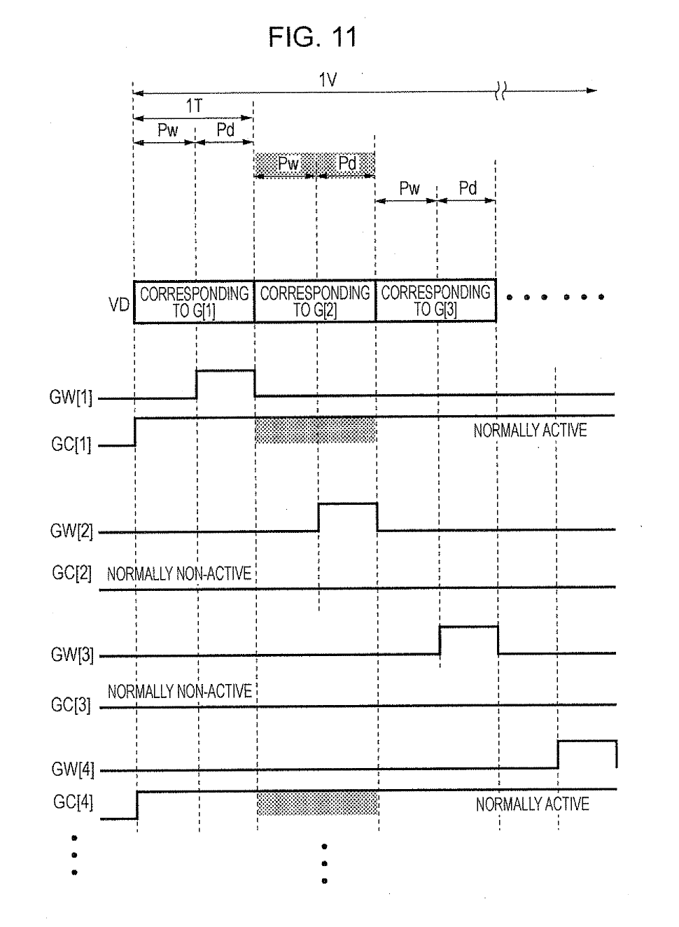

The electro-optic device according to the second embodiment including such a configuration, for example, operates and functions as follows. That is, first, in the writing period Pw shown in the leftmost side of FIG. 11, the scan line driving circuit 200 supplies the charging control signals GC[1], GC[4], . . . . , GC[m] in an active state to the remaining charging control lines 3C except the charging control line 3C included in the scan lines 3 of the second and third rows. Hereby, the first transistors Tr1 located at each of the rows except the second and third rows are in an on state, and therefore, the capacitor elements C1 belonging to each of the corresponding rows are in a state of conduction with the data line 6.

Thereafter, under the circumstances, the data potential generating section 301 is not different from the first embodiment in that the data potential VD[j] is supplied to each of the corresponding data lines 6, and that hereby, the charges based on the data potential VD[j] are accumulated in the capacitor element C1 corresponding to the first transistor Tr1 which is in an on state, and the like.

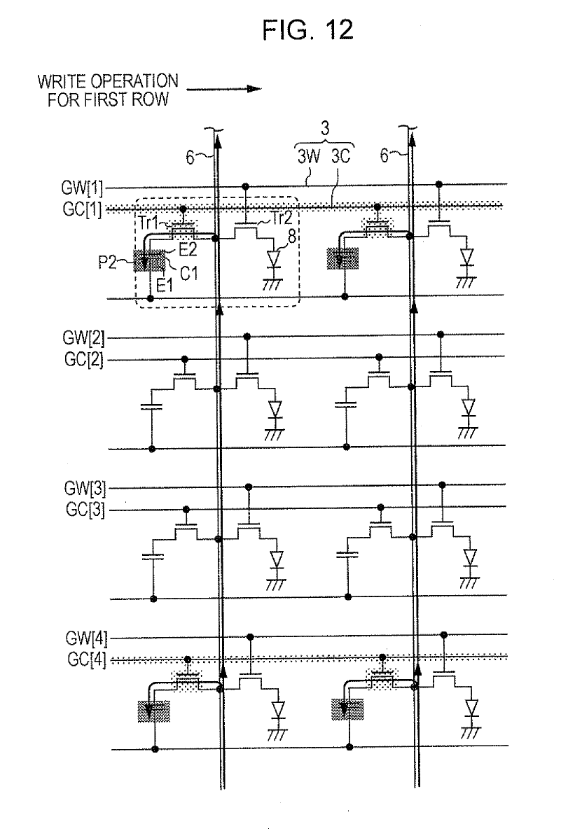

FIG. 12 visually represents the above-mentioned operation in the same meaning as in FIG. 4.

However, the second embodiment is characterized by the following point in this case. That is as shown in FIG. 11, the charging control lines 3C belonging to the second and third rows which are in a non-selected state in the above description are constantly non-selected. On the contrary, the charging control lines 3C which are in a selected state in the above description are constantly selected from this time on. This has no relation to concurrently performing an operation in which the electro-optic elements 8 to be emitted are sequentially selected in accordance with the line-sequential selection of the emission control line 3W.

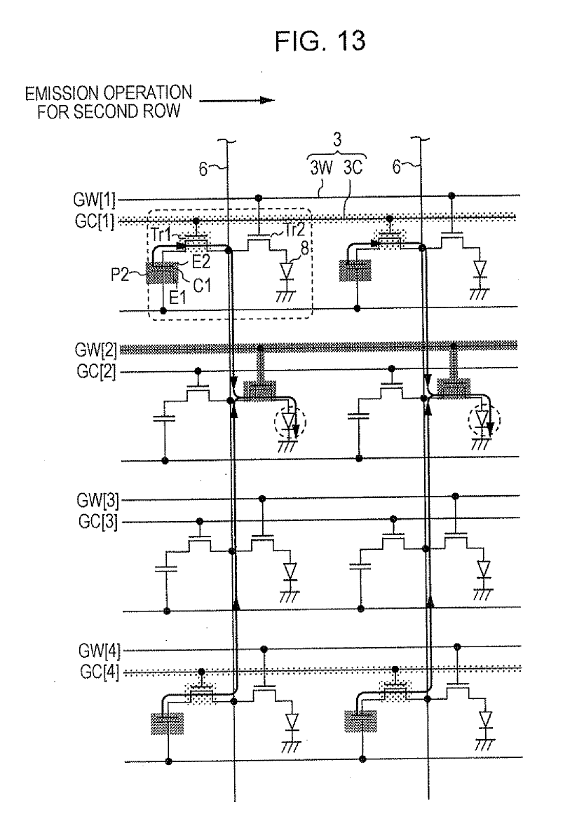

Actually, FIG. 13 visually represents this. That is, in FIG. 13, although the electro-optic element 8 to be emitted belongs to the second row, the elements functioning as a current supply source to the electro-optic element 8 are the capacitor elements C1 belonging to the first, fourth, fifth, . . . , m-th rows. This point is different from a point that, at least, the capacitor element C1 belonging to the row to which the electro-optic element 8 to be emitted belongs should be constantly charged and discharged in the first embodiment.

This background is greatly under the influence of the difference of the configurations between the first embodiment where the electro-optic element 8 and the capacitor element C1 are serially connected, and the second embodiment where the electro-optic element 8 and the capacitor element C1 are connected so as to be in a parallel relationship as viewed on the basis of the data line 6 (see FIG. 2 and FIG. 10 for comparison). In the second embodiment, it is not necessary for the capacitor element C1 belonging to the row to which the electro-optic element 8 to be emitted belongs to be charged and discharged.

It is obvious that the operational advantage which is not essentially different from the operational advantage obtained by the first embodiment is obtained by the second embodiment as described above. That is, in the above-mentioned example, an example in which the charging control lines 3C belonging to the second and third rows are non-selected has been incidentally described. However, since the number of the charging control lines 3C to be non-selected is basically freely determined in the second embodiment, it is possible to easily adjust the brightness of the whole image by the adjustment of increase and decrease in the number of the capacitor elements C1 involved in charging and discharging, similarly to the first embodiment.

In addition, according to the second embodiment, as in the first embodiment, the charging control line 3C to be non-selected and selected is not changed at every moment, but as described above, the charging control line 3C to be non-selected can be unselected always, or the charging control line 3C to be selected can be always selected, so that the low power consumption can be achieved.

Further, in the above description, the example in which the charging control line 3C to be unselected and selected is constantly fixed is described, but the invention is not limited thereto.

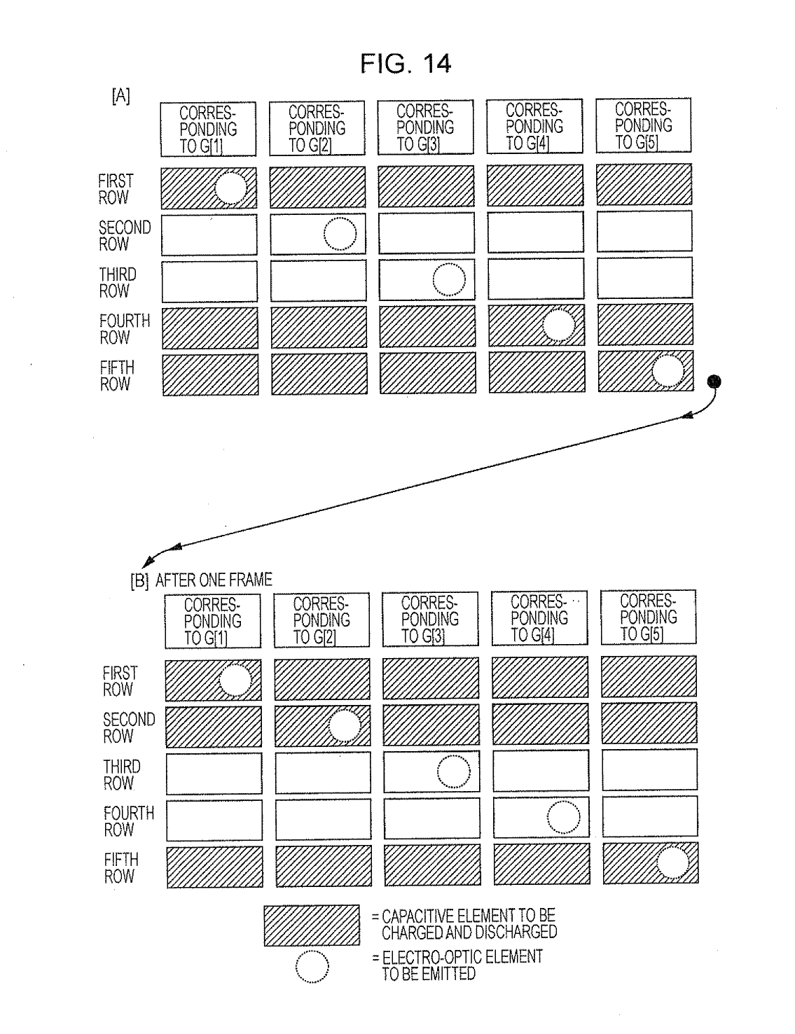

For example, as shown in FIG. 14, the case in which the charging control line 3C to be unselected and selected is changed in every predetermined period is also within the scope of the second embodiment of the invention. Further, FIG. 14 is a diagram illustrating the same gist as that shown in FIG. 6 described above, which is an a first explanatory diagram illustrating the time-dependent change of the positional relationship between the capacitor element C1 to be charged and discharged and the electro-optic element 8 to be emitted when the unit circuit P2 exists only in 5 rows×1 column.

In [A] of FIG. 14, as described above, the charging control line 3C belonging to the second and third rows is unselected, that is, the capacitor element C1 belonging to theses rows is not charged and discharged. However, in this case, [A] of FIG. 14 is only the illustration in which the charging control line 3C is unselected and selected in the first vertical period. In actual, as shown in FIG. 14 with an arrow, in [B] of FIG. 14 representing the next period, since the charging control line 3C to be non-selected belongs to the second and third rows, it is changed to belong to the third and fourth rows.

When the change operation is repeatedly performed, a state in which all the electro-optic element 8 are also driven under the same current supply condition as a whole (or, when it is viewed in time that the charging control line 3C to be non-selected takes a round), and as a result, the brightness unevenness reduce effect similar to the first embodiment can be achieved.

In addition, in the operation example as shown in FIG. 14, as described in the first embodiment, the charging control line 3C to be selected is not changed for each one horizontal period, the charging control line 3C to be selected is changed in every 1 vertical period, so that the number of change times is reduced compared with the first embodiment, which is not changed at all from the state described with reference to FIGS. 11 to 13. Therefore, according to the operation example as shown in FIG. 14, the above-mentioned power consumption reduce effect can be achieved.

Hereinbefore, the embodiments according to the invention have been described, but the electro-optic device according to the invention is not limited to the above-mentioned embodiments and various changes can be made.

(1) In the first and second embodiments described above, the capacitor element C1 included in the unit circuit P1 or P2 is charged in the writing operation described in “i” above, but the invention is not limited to the embodiments.

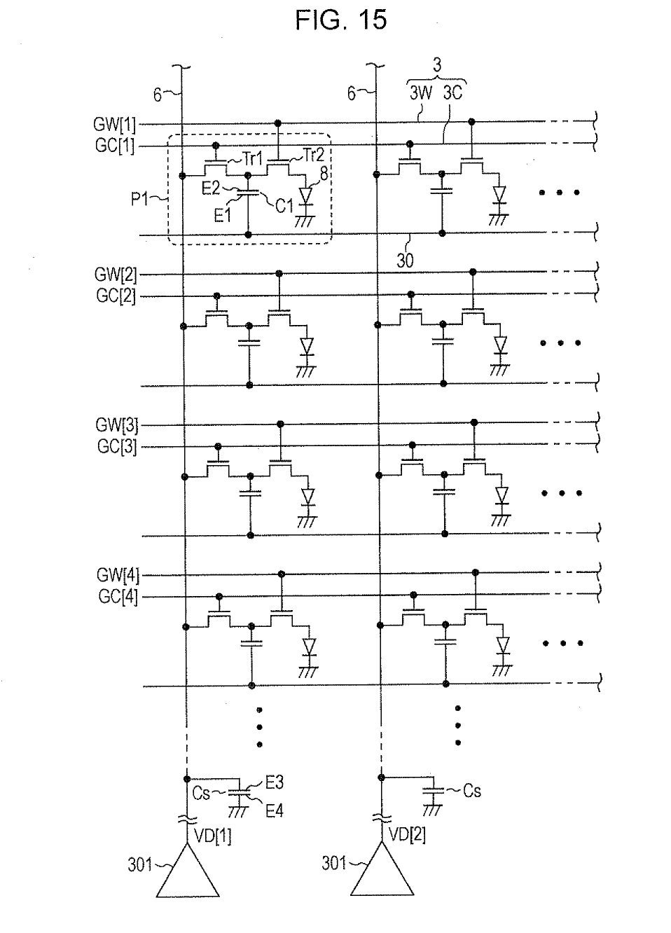

For example, as shown in FIG. 15, each data line 6 is connected to the auxiliary capacitor element Cs. One electrode E3 of the capacitor element Cs is connected to the data line 6, and the other electrode E4 is connected to a potential line to which a fixed potential is supplied. Further, FIG. 15 shows a state in which the configuration shown in FIG. 2 is added with the capacitor element Cs on the basis of the first embodiment, but it is a matter of course that the capacitor element Cs may be added on the basis of FIG. 10 according to the second embodiment.

In the configuration, the auxiliary capacitor element Cs is also charged in addition to the predetermined capacitor element C1 in the writing period Pw in each unit period 1T shown in FIG. 3 or 11. In addition, in the drive period Pd in each unit period 1T shown in the drawings, the charges from the auxiliary capacitor element Cs are supplied to the unit circuit P1 corresponding to the auxiliary capacitor element Cs.

According to the embodiment described above, even when a total value of capacitance of the capacitance elements C1 connected to the data line 6 corresponding to one electro-optic element 8 is not sufficient to make the amount of emission of the electro-optic element 8 sufficient, the insufficient amount can be compensated by using the capacitance of the auxiliary capacitor element Cs.

(2) In the first and second embodiments, each example of the relationship between the position of the capacitor element C1 to be charged and the position of the electro-optic element 8 to be emitted, that is, a specific example of “predetermined positional relationship” according to the invention has been described with reference to FIG. 6, 7 or 14, and the invention can be considered of various “positional relationships” other than the above relationship.

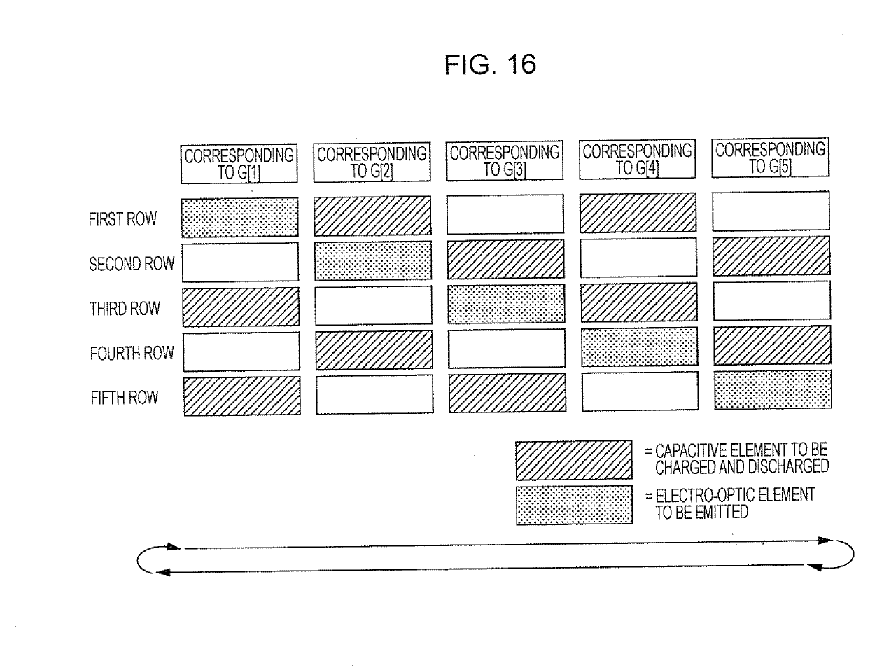

For example, on the basis of the first embodiment, as shown in FIG. 16, there may be a relationship in which the capacitor elements C1 to be charged are arranged in every other row as viewed from the electro-optic element 8 to be emitted.

In this regard, in the second embodiment, the configuration in which the capacitor element C1 to be charged and discharged is changed for each one frame has been described with reference to FIG. 14, but the invention cannot be limited to the configuration. The “predetermined period” according to the invention can be variously set such as for each five horizontal periods and for each three frames.

### Application

Next, the electronic device to which the electro-optic device 10 according to the embodiment is applied will be described.

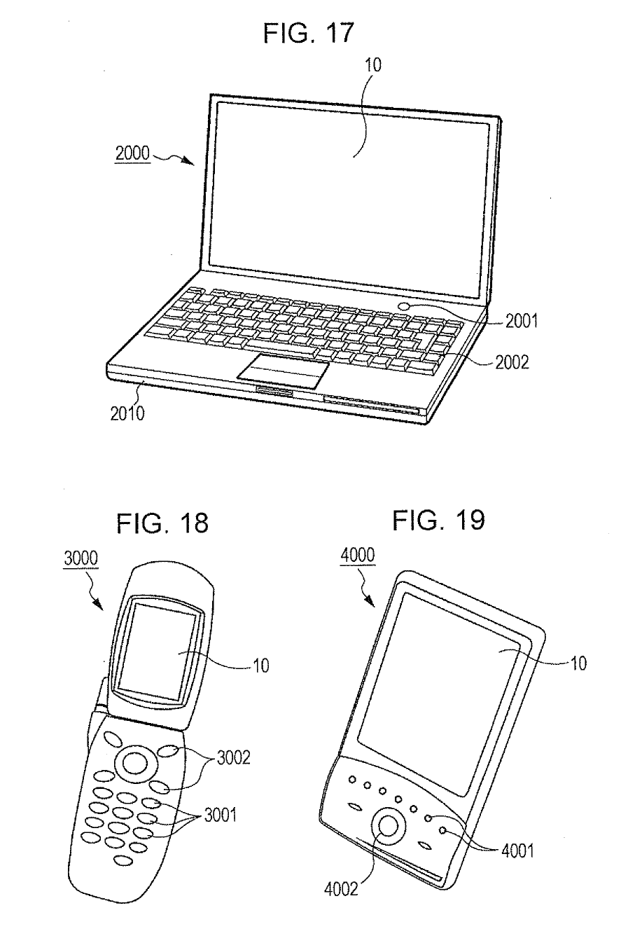

FIG. 17 is a perspective view illustrating the configuration of the mobile-type personal computer in which the electro-optic device 10 according to the above-mentioned embodiment is used in the image display device. The personal computer 2000 includes the electro-optic device 10 as a display device and a main body 2010. In the main body 2010, a power switch 2001 and a keyboard 2002 are provided.

FIG. 18 shows a mobile phone to which the electro-optic device 10 according to the embodiment is applied. The mobile phone 3000 includes a plurality of operation buttons 3001, a scroll button 3002, and the electro-optic device 10 as a display device. By operating the scroll button 3002, a screen displayed on the electro-optic device 10 is scrolled.

FIG. 19 shows a personal digital assistant (PDA) to which the electro-optic device 10 according to the embodiment is applied. The personal digital assistant 4000 includes a plurality of operation buttons 4001, a power switch 4002, and the electro-optic device 10 as a display device. When the power switch 4002 is operated, various types of information such as an address book or a schedule list are displayed on the electro-optic device 10.

As for the electronic device to which the electro-optic device according to the invention is applied, other than that shown in FIGS. 17 to 19, digital still cameras, televisions, video cameras, car navigations, pagers, electronic diaries, electronic papers, calculators, word processors, workstations, television phones, POS terminals, video players, mechanisms provided with a touch panel, and the like can be exemplified.

1. An electro-optic device comprising:
a plurality of unit circuits disposed corresponding to intersection of a plurality of scan lines and a plurality of data lines;
control lines extended corresponding to the plurality of each of the scan lines;
a scan line driving circuit that sequentially selects one of the scan lines for each drive period within each unit period, and selects all or a portion of the plurality of control lines; and
a data line driving circuit that outputs a data potential, in response to grayscale data of the unit circuit corresponding to the scan line selected in the drive period within the unit period, to each of the data lines, for each period within the unit period which is a writing period before the drive period is started,
wherein the plurality of each of the unit circuits includes:
an electro-optic element having a grayscale in response to the data potential;
a capacitor element which has a first and second electrodes and of which the first electrode is connected to a capacitor line;
a first switching element, disposed between the second electrode of the capacitor element and the data line, that causes the second electrode and the data line to be in a state of conduction by conducting at the time of selection of the control line in the writing period; and
a second switching element, disposed between the data line and the electro-optic element, that causes the data line and the electro-optic element to be in a state of conduction by conducting at time of selection of the scan line in the drive period.

2. The electro-optic device according to claim 1, wherein all of the plurality of control lines are not selected all at once in one of the writing periods.

3. The electro-optic device according to claim 1, wherein one end of the first switching element is connected to the data line, and
wherein the other end thereof is connected to the second electrode and is connected to one end of the second switching element.

4. The electro-optic device according to claim 1, wherein one end of the first switching element is connected to a first node on the data line,
wherein one end of the second switching element is connected to the first node, and
wherein the second switching element is disposed between the second electrode and the electro-optic element via the first node and the first switching element.

5. The electro-optic device according to claim 1, wherein a control line which is not selected, among the plurality of control lines, within one of the writing periods is defined by a predetermined positional relationship between the control line and one of the scan lines selected in the drive period corresponding to the writing period, and
wherein the predetermined positional relationship is constantly the same, regardless of which is one of the scan lines to be selected among the plurality of scan lines.

6. The electro-optic device according to claim 5, wherein a relationship, where one of the control lines corresponding to one of scan lines which is adjacent to one of the scan line selected in the drive period is not selected constantly, is included in the predetermined positional relationship.

7. The electro-optic device according to claim 4, wherein a control line selected among the plurality of control lines is constantly fixed in a predetermined period.

8. The electro-optic device according to claim 7, wherein the predetermined period is one frame.

9. An electronic device comprising the electro-optic device according to claim 1.

10. A method of driving an electro-optic device that includes a plurality of control lines extended corresponding to a plurality of each of scan lines, and a plurality of unit circuits corresponding to each of the control lines, and includes an electro-optic element having a predetermined grayscale by charge discharging of a capacitor element within the corresponding unit circuit, comprising:
causing a first switching element between the capacitor element within the unit circuit corresponding to the control line and a data line to be in a conduction state by selecting all or a portion of the plurality of control lines, and accumulating charges, in response to a data potential output to the data line, in the capacitor element, and
causing a second switching element between the electro-optic element within the unit circuit corresponding to the scan line and the data line to be in a conduction state by selecting one of the scan lines.
